(19) United States
(12) Patent Application Publication
(10) Pub. No.: US 2026/0179364 A1
(43) Pub. Date: Jun. 25, 2026

(54) INFORMATION PROCESSING DEVICE

(71) Applicant: TOYOTA JIDOSHA KABUSHIKI KAISHA, Toyota-shi (JP)

(72) Inventor: Satoshi MIYAKE, Toyota-shi (JP)

(73) Assignee: TOYOTA JIDOSHA KABUSHIKI KAISHA, Toyota-shi (JP)

(21) Appl. No.: 19/405,673

(22) Filed: Dec. 2, 2025

(30) Foreign Application Priority Data
Dec. 23, 2024 (JP) 2024-226693

(51) Int. Cl. G06V 10/774; G06V 10/25; G06V 10/40

(52) U.S. Cl. CPC G06V 10/774; G06V 10/25; G06V 10/40; G06V 2201/07

(57) ABSTRACT

An information processing device includes: a first acquisition unit configured to acquire a sample image of a target object; an extraction unit configured to extract a target feature related to the target object from the sample image; a second acquisition unit configured to acquire a target image to be annotated; a detection unit configured to detect, using the target feature, a region in the target image that contains the target object; and an annotation unit configured to execute, on the region containing the target object, annotation related to the target object.

### CROSS-REFERENCE TO RELATED APPLICATION

This application claims priority to Japanese Patent Application No. 2024-226693 filed on Dec. 23, 2024. The disclosure of the above-identified application, including the specification, drawings, and claims, is incorporated by reference herein in its entirety.

### BACKGROUND

### 1. Technical Field

The present disclosure relates to the technical field of information processing devices.

### 2. Description of Related Art

As an example of this type of device, a system has been proposed in which a large language model (LLM) is used to generate query data based on documents, and pairs of the documents and the query data are used to train a retrieval model for a dialogue bot (see Japanese Unexamined Patent Application Publication No. 2023-076413 (JP 2023-076413 A)).

### SUMMARY

Machine learning often demands a large amount of pre-annotated training data. For example, when training a model for detecting objects contained in images, annotation work needs to be carried out for a large amount of image data. However, automatic annotation is difficult for objects having special structures (for example, dedicated components used only in a limited number of products). In such cases, annotation work is performed manually, leading to technical issues such as increased labor and higher cost.

The present disclosure has been made in view of the above issues, and an object thereof is to provide an information processing device capable of appropriately executing annotation on image data.

An information processing device according to one aspect of the present disclosure includes: a first acquisition unit configured to acquire a sample image of a target object; an extraction unit configured to extract a target feature related to the target object from the sample image; a second acquisition unit configured to acquire a target image to be annotated; a detection unit configured to detect, using the target feature, a region in the target image that contains the target object; and an annotation unit configured to execute, on the region containing the target object, annotation related to the target object.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a hardware configuration of an information processing device according to an embodiment;

FIG. 2 is a block diagram illustrating a functional configuration of the information processing device according to the embodiment;

FIG. 3 is a flowchart illustrating an extraction operation performed by the information processing device according to the embodiment; and

FIG. 4 is a flowchart illustrating an annotation operation performed by the information processing device according to the embodiment.

### DETAILED DESCRIPTION OF EMBODIMENTS

An embodiment of an information processing device will be described below with reference to the drawings.

### Hardware Configuration

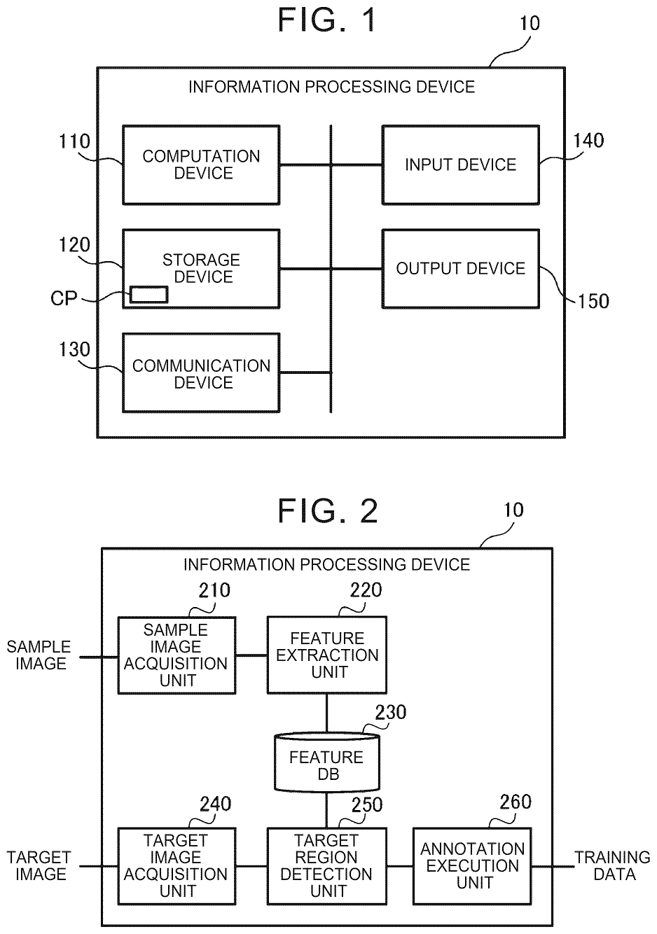

First, a hardware configuration of the information processing device according to the embodiment will be described with reference to FIG. 1. FIG. 1 is a block diagram illustrating the hardware configuration of the information processing device according to the embodiment.

In FIG. 1, an information processing device 10 according to the embodiment includes a computation device 110, a storage device 120, a communication device 130, an input device 140, and an output device 150. The computation device 110, the storage device 120, the communication device 130, the input device 140, and the output device 150 are connected to each other via a data bus.

The computation device 110 is configured to execute various computation processes in the information processing device 10. The computation device 110 may include a processor. The computation device 110 may include a single processor or may include a plurality of processors. In other words, the computation device 110 may include one or more processors. The processor may be a multicore processor. When the computation device 110 includes a single processor that is a multicore processor, the computation device 110 can logically be regarded as including a plurality of processors.

The processor included in the computation device 110 may be, for example, at least one of the following: a central processing unit (CPU), a graphics processing unit (GPU), a field programmable gate array (FPGA), and a tensor processing unit (TPU).

The storage device 120 may be, for example, at least one of the following: a random access memory (RAM), a read-only memory (ROM), a hard disk drive, a magneto-optical disk drive, a solid-state drive (SSD), and an optical disk array. That is, the storage device 120 may be implemented using a single device or may be implemented using a plurality of devices.

The storage device 120 is capable of storing desired data. The storage device 120 may store a computer program CP that is executed by the computation device 110. When the computation device 110 is executing the computer program CP, the storage device 120 may temporarily store data temporarily used by the computation device 110.

The computer program CP may be recorded on a computer-readable and non-transitory recording medium. In this case, the computer program CP may be stored in the storage device 120 by reading the recording medium using a recording medium reader (not shown) included in the information processing device 10. At least one of the following media may be used as the recording medium: an optical disk, a magnetic medium, a magneto-optical disk, a semiconductor memory, and any other medium capable of storing programs. The computer program CP may be acquired from a device (not shown) external to the information processing device 10 via the communication device 130. In other words, the computer program CP may be downloaded from an external device to the storage device 120 of the information processing device 10.

The computation device 110 (e.g., a processor), together with the storage device 120 storing the computer program CP (in other words, together with the storage device 120 and the computer program CP stored in the storage device 120), may execute processing to be performed by the information processing device 10. For example, logical functional blocks for executing the processing to be performed by the information processing device 10 may be implemented within the computation device 110 (e.g., within the processor) by the computation device 110 executing the computer program CP.

The communication device 130 is configured to communicate with a device external to the information processing device 10. The communication device 130 may perform wired communication or wireless communication.

The input device 140 is a device capable of receiving information input from outside to the information processing device 10. The input device 140 may include an operation device operable by a user of the information processing device 10 (e.g., a keyboard, a mouse, a touch panel, etc.). The input device 140 may include a recording medium reader capable of reading information recorded on a recording medium (such as a Universal Serial Bus (USB) memory) that is attachable to and detachable from the information processing device 10. When information is input to the information processing device 10 via the communication device 130 (in other words, when the information processing device 10 acquires information via the communication device 130), the communication device 130 may serve as an input device.

The output device 150 is a device capable of outputting information to the outside of the information processing device 10. The output device 150 may include a display device capable of outputting visual information such as text or images as the output information. The output device 150 may include a speaker capable of outputting auditory information such as sound as the output information. The output device 150 may be configured to output the above information (e.g., control information for other devices) to other devices. The output device 150 may be capable of outputting information to a recording medium that is attachable to and detachable from the information processing device 10, such as a USB memory. When the information processing device 10 outputs information via the communication device 130, the communication device 130 may serve as an output device.

### Functional Configuration

Next, a functional configuration of the information processing device 10 according to the embodiment will be described with reference to FIG. 2. FIG. 2 is a block diagram illustrating the functional configuration of the information processing device according to the embodiment.

In FIG. 2, the information processing device 10 is configured as a device that executes annotation on image data. The information processing device 10 includes, as components for implementing its functions, a sample image acquisition unit 210, a feature extraction unit 220, a feature database (DB) 230, a target image acquisition unit 240, a target region detection unit 250, and an annotation execution unit 260. Each of the sample image acquisition unit 210, the feature extraction unit 220, the target image acquisition unit 240, the target region detection unit 250, and the annotation execution unit 260 may be processing blocks implemented by the computation device 110 described above. The feature DB 230 may be a database implemented by the storage device 120 described above.

The sample image acquisition unit 210 is configured to acquire a sample image. The sample image is an image containing a target object. The target object is an object to be annotated. The target object may be an object detected from an image in an image recognition process. For example, the target object may be a component used in manufacturing a product. The sample image acquisition unit 210 may be configured to acquire a plurality of sample images at a time.

The feature extraction unit 220 is configured to extract a feature or features related to the target object (hereinafter referred to as “target features” as appropriate) from a sample image acquired by the sample image acquisition unit 210. The method for extracting target features from a sample image is not particularly limited. The feature extraction unit 220 may extract the target features from the sample image using, for example, a machine-learned model.

The feature DB 230 is configured to store the target features extracted by the feature extraction unit 220. The feature DB 230 may be configured to store the target features in association with, for example, the name or ID of the target object. The target features stored in the feature DB 230 can be read as appropriate by the target region detection unit 250.

The target image acquisition unit 240 is configured to acquire a target image. The target image is an image to be annotated. The target image acquisition unit 240 may be configured to acquire a plurality of target images at a time.

The target region detection unit 250 is configured to detect, from a target image acquired by the target image acquisition unit 240, a region containing a target object (hereinafter referred to as “target region” as appropriate). The target region detection unit 250 detects the target region in the target image using the target features stored in the feature DB 230. More specifically, the target region detection unit 250 detects, as a target region, a location in the target image having features that match the target features (for example, features having a similarity that is greater than or equal to a predetermined threshold). The target region detection unit 250 may detect a plurality of target regions from a single target image.

The annotation execution unit 260 executes annotation on the target region detected by the target region detection unit 250. Specifically, the annotation execution unit 260 assigns, to the target region in the target image, ground-truth data indicating that the region contains the target object. For example, when a target region of component A is detected from a target image, the annotation execution unit 260 may assign, to the detected target region, ground-truth data indicating that the region contains component A.

### Extraction Operation

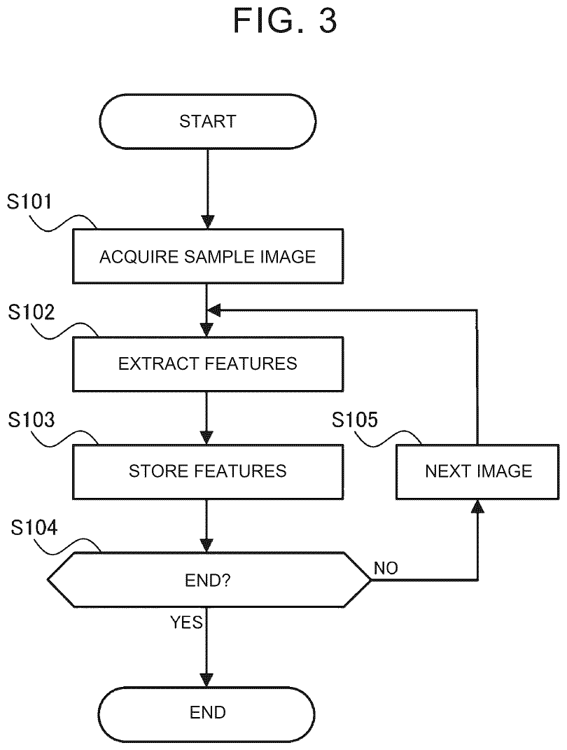

Next, an extraction operation performed by the information processing device 10 according to the embodiment (specifically, an operation performed when extracting features of a target object from a sample image) will be described with reference to FIG. 3. FIG. 3 is a flowchart illustrating the extraction operation performed by the information processing device according to the embodiment.

As shown in FIG. 3, when the extraction operation by the information processing device 10 according to the embodiment is started, the sample image acquisition unit 210 first acquires a sample image (step S101). The feature extraction unit 220 then extracts target features from the sample image acquired by the sample image acquisition unit 210 (step S102).

Thereafter, the feature DB 230 stores the target features extracted by the feature extraction unit 220 (step S103). Subsequently, the information processing device 10 determines whether to end the extraction operation (step S104). For example, the information processing device 10 may determine to end the extraction operation when the target features have been extracted from all of the sample images acquired by the sample image acquisition unit 210.

When it is determined not to end the extraction operation (step S104: NO), the processing target is shifted to the next sample image (step S105), and the process returns to step S102. By repeating such processing, target features are extracted from all of the sample images acquired by the sample image acquisition unit 210. On the other hand, when it is determined to end the extraction operation (step S104: YES), the series of operations ends.

### Annotation Operation

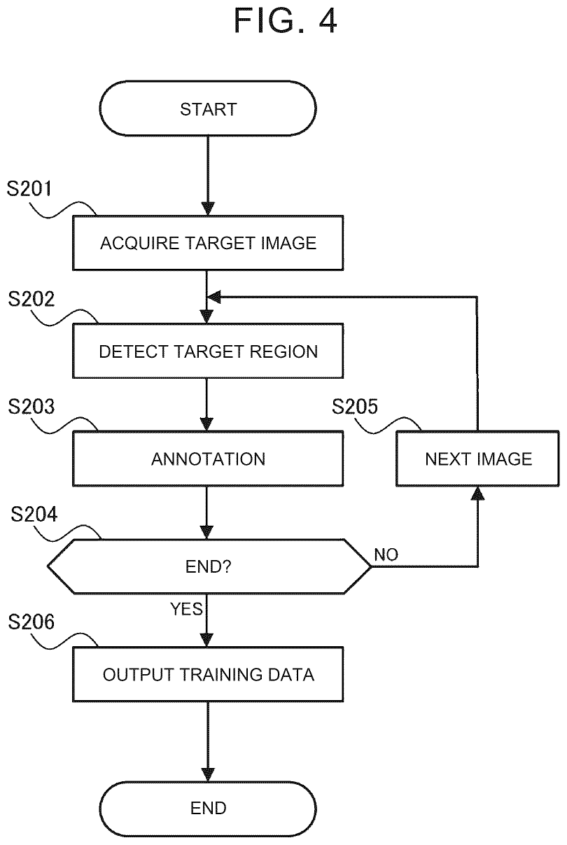

Next, an annotation operation performed by the information processing device 10 according to the embodiment (specifically, an operation performed when executing annotation on a target image) will be described with reference to FIG. 4. IG. 4 is a flowchart illustrating the annotation operation performed by the information processing device according to the embodiment.

As shown in FIG. 4, when the annotation operation by the information processing device 10 according to the embodiment is started, the target image acquisition unit 240 first acquires a target image (step S201). The target region detection unit 250 then detects a target region from the target image acquired by the target image acquisition unit 240 using the target features stored in the feature DB 230 (i.e., the features of the target object extracted in the extraction operation described above) (step S202).

Thereafter, the annotation execution unit 260 executes annotation on the target region detected by the target region detection unit 250 (step S203). Subsequently, the information processing device 10 determines whether to end the annotation operation (step S204). For example, the information processing device 10 may determine to end the annotation operation when annotation has been executed for all of the target images acquired by the target image acquisition unit 240.

When it is determined not to end the annotation operation (step S204: NO), the processing target is shifted to the next target image (step S205), and the process returns to step S202. By repeating such processing, annotation is executed for all of the target images acquired by the target image acquisition unit 240. On the other hand, when it is determined to end the annotation operation (step S204: YES), the annotation execution unit 260 outputs, as training data, the target images for which annotation has been executed (specifically, pairs of target images and ground-truth data) (step S206).

### Technical Effects

Next, technical effects obtained by the information processing device 10 according to the embodiment will be described.

As described with reference to FIGS. 1 to 4, in the information processing device 10 according to the embodiment, annotation of a target image is executed based on target features extracted from sample images. Annotation of image data can thus be appropriately executed.

For example, there is no need to manually (for example, visually) identify a target object to be annotated. In addition, the accuracy of detecting a target region in a target image is also improved. Specifically, since target features extracted from sample images are stored in advance, it is possible to detect with high accuracy and annotate even target objects that cannot be detected by a general-purpose model (for example, dedicated components). As a result, for example, training of an image recognition model (for example, a model that recognizes objects contained in images) can be appropriately executed.

Aspects of the disclosure derived from the above embodiment will be described below.

An information processing device according to one aspect of the present disclosure includes: a first acquisition unit configured to acquire a sample image of a target object; an extraction unit configured to extract a target feature related to the target object from the sample image; a second acquisition unit configured to acquire a target image to be annotated; a detection unit configured to detect, using the target feature, a region in the target image that contains the target object; and an annotation unit configured to execute, on the region containing the target object, annotation related to the target object. In the above embodiment, the “sample image acquisition unit 210” is an example of the “first acquisition unit,” the “feature extraction unit 220” is an example of the “extraction unit,” the “target image acquisition unit 240” is an example of the “second acquisition unit,” the “target region detection unit 250” is an example of the “detection unit,” and the “annotation execution unit 260” is an example of the “annotation unit.”

In the information processing device according to the above aspect, the first acquisition unit may be configured to acquire a plurality of the sample images, the extraction unit may be configured to extract a plurality of the target features from the sample images, and the detection unit may be configured to detect the region containing the target object using the target features. In this way, it becomes possible to detect a plurality of types of objects contained in a target image.

The present disclosure is not limited to the embodiment described above, and various modifications can be made as appropriate without departing from the gist or spirit of the disclosure as understood from the claims and the entire specification. Information processing devices incorporating such modifications are also within the technical scope of the present disclosure.

What is claimed is:

1. An information processing device comprising:
a first acquisition unit configured to acquire a sample image of a target object;
an extraction unit configured to extract a target feature related to the target object from the sample image;
a second acquisition unit configured to acquire a target image to be annotated;
a detection unit configured to detect, using the target feature, a region in the target image that contains the target object; and
an annotation unit configured to execute, on the region containing the target object, annotation related to the target object.

2. The information processing device according to claim 1, wherein:
the first acquisition unit is configured to acquire a plurality of the sample images;
the extraction unit is configured to extract a plurality of the target features from the sample images; and
the detection unit is configured to detect the region containing the target object using the target features.
